(19) United States
(12) Patent Application Publication
(10) Pub. No.: US 2011/0073534 A1
(43) Pub. Date: Mar. 31, 2011

(54) Sorting Installation and Method for Sorting Articles

(76) Inventors: Niels Linge, Pirmasens (DE); Andreas Luetz, Pirmasens (DE); Hans Gerhard Schehl, Pirmasens (DE); Volker Welsch, Pirmasens (DE); Werner Utzinger, Pirmasens (DE); Klaus Hickethier, Pirmasens (DE); Martin Mueller, Pirmasens (DE)

(21) Appl. No.: 12/568,422

(22) Filed: Sep. 28, 2009

(51) Int. Cl. B07C 7/04

(52) U.S. Cl. 209/705

(57) ABSTRACT

Sorting installation with a sorting area for sorting articles from source containers into target containers by means of a sorting person located in the sorting area. The sorting installation includes at least one target container revolving conveyer device adjacent to the sorting area, which is provided such that it supplies a plurality of target containers along a target container conveying circuit in a conveying circuit plane to the sorting person in the sorting area in a repeated and revolving manner until the respective target container is loaded with articles from one or a plurality of source containers up to a predetermined degree, wherein the conveying circuit plane of the target container conveying circuit of the respective target container revolving conveying device extends substantially vertically and crosses the sorting area, and a target container conveying installation for supplying and returning target containers to and from the at least one target container revolving conveyer device.

### I. FIELD OF THE INVENTION

The invention relates to a sorting installation and a method for sorting articles from source containers into target containers.

The term container includes any transport and storage means, such as boxes, cartons, etc., and also such means which do not enclose a hollow volume for receiving articles, such as pallets, hallstands, clothes hangers, etc. Articles can be any kind of goods, such as textiles, furniture, furniture parts, machine elements, such as screws, nuts, springs, etc., or any other parts to be sorted. By sorting, we generally mean any process of unloading articles from one or more source containers and loading the articles into one or more target containers.

### II. BACKGROUND

Typically (and also in the context of the invention), articles to be sorted are arranged in source containers, also called storage containers, in an article store, such as a high-bay racking, to which a source container conveying installation, such as a storage and retrieval unit for high-bay warehouse with for example a path conveyer assigned thereto, is connected, by which the source containers are transported to a sorting area, in which a sorting person (sorter) is located. The sorting area may be a standing or seated working place. The sorting person manually sorts articles from the source containers into target containers which are also called order containers (i.e., manual input of articles from source containers into target containers according to a predetermined sorting plan). The sorting area normally has small dimensions so that the sorting person does not have a long distance between the source and target containers.

For today's high performance sorting systems it is usually desirable to achieve 1000 or more picks of articles per hour per sorting person. That is, the sorting installation has to allow a respective sorting person (of a plurality of sorting persons) to pick 1000 or more articles per hour from diverse source containers and to sort them into diverse target containers. Such a volume may overload the source container conveying installation connected to the article storage, such as a storage and retrieval unit for high-bay warehouse which takes out the source containers from a rack and sorts them back into such a rack.

Relief for the source container conveying installation may be provided, for example, by a source container buffer. Such a source container buffer can, for example, as described in EP 0 860 382 A1, be provided in a source container supply channel branched off from a source container distribution system, wherein the source container distribution system is often provided as a circular conveyer, such as is also described in EP 0 860 382 A1, and, thus, also forms a buffer. Because source containers are located in the buffer, these source containers can be accessed locally, that is, accessed outside and, hence, independently from the actual article storage, so that the source container conveyer installation in the article storage is relieved.

DE 102 00 077 A1 shows a sorting system with a decoupling buffer, wherein source containers with articles to be sorted are supplied to and returned from a sorting person from/to a storage via a conveying path, wherein target containers, into which the articles are sorted, are temporarily stored in a buffer rack and are respectively supplied to the sorting person via a storage and retrieval unit assigned to the buffer rack.

DE 40 16 810 C1 discloses a rack storage for bar-shaped material received in self-carrying elongate cassettes, wherein the cassettes are arranged in racks which are arranged adjacent to each other in a direction transverse to the longitudinal direction of the cassettes. By means of a transport carriage, which is movable transverse to the longitudinal direction of the cassettes, cassettes can be taken out of the racks and can be transported to an input/output station, at which an operator can load articles for input into the cassettes and can unload articles for output from the cassettes. The station consists of an upper conveying path which receives cassettes from the transport carriage for supplying to the operator, and a lower conveying path, via which cassettes are transported back to the transport carriage to be brought back to the rack by the transport carriage.

### III. SUMMARY OF INVENTION

The sorting installation and the method for sorting articles according to the invention allow an efficient sorting process with 1000 or more picks per hour per sorting person, wherein a source container conveyer installation which accesses an article storage is relieved, and wherein the sorting installation is space saving and cost efficient.

According to an embodiment of the invention a sorting installation includes a sorting area for sorting articles from source containers into target containers by a sorting person located in the sorting area, a plurality of target container revolving conveyer devices which are arranged adjacent to the sorting area, each of which is provided such that it supplies to the sorting person located in the sorting area a plurality of target containers along a target container conveying circuit extending in a conveying circuit plane in a repeated and revolving manner until the respective target container is loaded with articles from one or a plurality of source containers up to a predetermined degree, for example completely, wherein the conveying circuit plane of the target container conveying circuit of the respective target container revolving conveyer device extends vertically and crosses the sorting area, a target container conveyer installation for supplying and returning target containers to/from the respective target container revolving conveyer device, and a source container conveyer system for automatically conveying source containers from an article storage to the sorting area and for automatically conveying back source containers from the sorting area to the article storage.

Since according to the invention, a plurality of target containers are always supplied to the sorting person in the sorting area in a revolving and repeated manner, it is possible to first sort the articles from a single source container into the plurality of target containers. That is, it is not necessary to access other source containers for a certain time, whereby the conveyer system accessing the source containers in the article storage is relieved. Nevertheless the sorting process is highly efficient (i.e., high number of picks), since in connection with the revolving of the target containers it is possible to continuously carry out the sorting process. Only when each of the revolving target containers is loaded with articles of the one source container in accordance with a predetermined requirement, does a new source container need to be supplied to the sorting area. It should be noted that it is possible, that all of the revolving target containers will be completely loaded with articles from diverse source containers. That is, if all target containers are, for example completely, loaded with articles from a source container, then another source container with further or other articles is supplied to the sorting person in the sorting area, which sorting person then may completely load all of the revolving target containers with these further or other articles of the other source container, and so on, until all target containers are finally and completely loaded. That is all target containers are finally loaded according to an initial order with all desired articles in the respectively desired numbers for final delivery of the target container.

It is also possible to predetermine a lower loading degree for the respective target container revolving conveyer device. For example, the respective target container may only be loaded with articles of a single particular type of one or a plurality of source containers assigned to this article type and may then be taken away from the target container revolving conveyer device by the target container conveyer installation. The respective target container may then, for example, be inserted by the target container conveyer installation in the target container revolving conveyer device of another correspondingly structured sorting installation, where this respective target container may then be further loaded in accordance with the invention with another article from another source container by the sorting person located there. This way of proceeding may be repeated until the final complete loading (degree) of the respective target container is achieved.

The source containers may contain/carry articles of one type (i.e., mono-material source container) or may also contain/carry a plurality of articles of different types. Accordingly, containers may, for example, contain pieces of clothing (i.e., article) of different colors (type) or pieces of clothing (i.e., article) of different kind (type) such as trousers, blouses, and/or T-shirts. The sorting person receives clear instructions via a display, which article and/or which article type and/or which amount of this article type is to be loaded into the respective target container. For example, respectively similar articles of similar type and, for example, at similar number are loaded into the target containers of a respective revolution.

The sorting area is to be understood as that area in which the sorting person is located for sorting the articles from the source containers into the target containers. That is, the sorting area forms the working area/working space of the sorting person. The sorting area is usually a horizontal plane, on which the sorting person stands or is seated via a seating-accommodation. The sorting area is out of the article storage. That is, the sorting area is outside of, for example, corridors between the storage racks of the article storage. Since the conveying circuit plane (imaginarily) extends through the sorting area, the sorting area is located on the front end side of the conveying circuit, that is, on the conveying loop thereof.

The empty target containers may be automatically supplied to the sorting area by a target container conveyer system which, in accordance with the invention, includes the target container revolving conveyer device and the target container conveying installation, and the loaded target containers are automatically returned from the sorting area by the conveyer system. By means of the source container conveyer system the source containers are automatically conveyed from the article storage towards the sorting area and automatically supplied to the sorting person. Such source containers that may still be partially filled with articles may be automatically transported back from the sorting area to the article storage by means of the source container conveyer system. Empty source containers may, for example, be manually taken away from the conveyer system at the sorting area and may be brought to a source container collecting location, or they may also be automatically carried away from the sorting area and, for example, be automatically taken away from the source container conveyer system at a location between the article storage and the sorting area and be automatically transported to the empty source container collecting location. There is also the possibility, to immediately re-use empty source containers as target containers.

The target container revolving conveyer device may be provided as a paternoster device, in which the containers are suspended on a revolving line/strand, for example a revolving chain, which, for example, is driven by an electric motor. The target container revolving conveyer device may also be provided as a shifting mechanism, including two substantially horizontally arranged and substantially linear conveying paths which are arranged at a vertical distance one above the other, wherein one of the two conveying paths forms a supply strand and the other one forms a return strand (that is, they supply and return, respectively, containers with respect to the sorting area). At the ends of the linear conveying paths there may be a respective transfer device in the form of a lift device for transporting target containers from the return strand to the supply strand and/or the other way around. The revolving operation can be provided reversible in its conveying direction. That is, the upper conveying path may be selectively supplying strand or return strand. The same accordingly also applies for the lower conveying path. This provides the possibility that depending on the distance of a target container, which is in the target container revolving conveyer circuit, to the sorting area, this target container, on request (that is, if, for example, according to a control program it is requested that now this target container is to be (further) loaded) can be conveyed to the sorting area either in the one or in the other revolving direction. In this case, it will be conveyed in that revolving direction which corresponds to the shortest distance of said target container to the sorting area, whereby the conveying time is further reduced and, hence, the efficiency of the sorting device is further increased. In the same way conveying of source containers in their respective source container revolving conveyer circuit can be carried out.

The drive means for driving the substantially horizontal conveying paths may be provided as an electric motor drive. The drive means may also be provided as respective gravity drive means, wherein the conveying paths may then be inclined by about 3-5° relative to the horizontal (such small inclinations are still to be interpreted to be substantially horizontal). Both conveying paths may be slightly inclined so as to slope towards the sorting area, so that that conveying path, which is used for returning containers, should be provided with an additional drive means for overcoming the gravity. It is also possible to supply the target containers on the lower conveying path via gravity (for example, via the conveying path being inclined by 3-5°) and to manually shift back the target containers on the upper conveying path, wherein the upper conveying path, for example, may be provided as a non-inclined horizontal roller path. It is also possible to provide an automatic drive means (including gravity drive means) for the upper conveying path. At that front end of the conveying paths, which faces the sorting area, the vertical transmission of the target container from the one conveying path (supply conveying path) to the other conveying path (return conveying path) may be carried out manually. However, according to another embodiment, at both front ends of the target container revolving conveyer device there are provided electric motor driven lift devices for transferring the target containers from the one to the other conveying path, that is, from the one to the other strand.

The upper conveying path is, for example, arranged on a working level (approximately 1100 mm above ground level of sorting area) so that the sorting person has easy access to that target container of the target container revolving conveyer device, which is positioned at that end of the upper conveying path of the target container revolving conveyer device, which faces the sorting person. If a plurality of target containers, for example six or more target containers, are allowed to revolve in the target container revolving conveyer device, the target container revolving conveyer device, for example, extends with its upper conveying path (for example, provided as return strand) and with its lower conveyer path (for example, provided as supply strand) substantially in an elongated horizontal manner, so that the target containers are transported substantially horizontally toward the sorting person in the sorting area and are correspondingly horizontally transported away therefrom.

Thus, the target containers revolve in a target container conveying circuit, that is, in a target container conveying loop, which defines a conveying circuit plane which in accordance with the invention extends vertically and crosses the sorting area. (That is, the imaginary plane, but not the actual conveying circuit with the target containers as a structure extends through the sorting area). This has the effect that, when seen by the sorting person located on the front end side of the corresponding target container revolving conveyer circuit, that is, located on the front end side of the corresponding target container conveying circuit, the target container revolving conveyer device can be structured/dimensioned in a very narrow manner, that is, it can be structured with a small width. The width of the target container revolving conveyer device is, for example, adapted to the width of the corresponding target containers (i.e., similar width). For example, target containers having a width of 400-500 mm may be used, which are transported by means of a target container revolving conveyer device of similar or slightly larger width.

This provides that a plurality of target container revolving conveyer devices with their conveying circuit planes arranged in parallel to each other can be arranged adjacent to each other in a row with very little distance therebetween or even abutting each other, wherein they can be operated by the same sorting person, since the sorting area is all in all kept small. The width of the sorting area then substantially corresponds to the overall width of the target container revolving conveyer devices arranged adjacent to each other.

It is possible to arrange four to six or even more target container revolving conveyer devices in parallel to each other and adjacent to each other in a row and to have them operated by a single sorting person.

The target containers may be directly inserted into the respective target container revolving conveyer device and taken away therefrom and put into a completed target container storage or put into a next, for example adjacent, target container revolving conveyer device by means of, for example, a gripper device (target container conveyer system). According to another embodiment, the target container conveyer installation includes a target container supply transport path, by which the target containers are transported to the respective target container revolving conveyer device, where, on need, they may be transferred to the respective target container revolving conveyer device by means of a transfer device. Further, the target container conveyer installation may include a target container return transport path, to which loaded target containers are transferred from the target container revolving conveyer device by means of a transfer device. The target container supply transport path and the target container return transport path may also be provided as a single (bi-directional) transport path. A sensor device, such as a bar code scanner or an RFID tag scanner, may recognize whether, when, where, and how a target container is to be supplied or is to be returned, in order to control forward systems/transfer systems to carry out the correspondingly required forwarding/transferring processes.

The source containers may be supplied to the respective sorting area and returned therefrom in a sideward manner, for example, by means of a transport path which extends cross-wise over the target container revolving conveyer device(s), that is, transverse to the respective conveying circuit plane and, hence, parallel to the sorting area. According to an embodiment, in the position facing the respective sorting area, the source containers may be automatically and slightly tilted towards the sorting area by means of a tilt mechanism so that the sorting person can more easily access the articles in the respective source container.

According to an embodiment of the invention the source container conveyer system includes at least one source container revolving conveyer device arranged adjacent to the sorting area and which is provided such that it supplies a plurality of the source containers in a source container conveying circuit in a conveying circuit plane to the sorting person located in the sorting area in a revolving and repeated manner until the predetermined number of articles, for example all articles, are sorted from the respective source container into the target containers, and a source container conveyer installation for supplying source containers to the at least one source container revolving conveyer device and for returning the source containers therefrom, wherein the conveying circuit plane of the source container conveying circuit of the respective source container revolving conveyer device extends vertically and crosses the sorting area.

According to this embodiment the source containers are (finally) supplied to the sorting person by means of a source container revolving conveyer device. The conveyer system assigned to the source containers therefore comprises the source container conveyer installation for bi-directionally transporting source containers between the article storage and the source container revolving conveyer device as well as the source container revolving conveyer device for finally supplying the source containers to the sorting area and, hence, to the sorting person. The source container revolving conveyer device, for example, is structured in accordance with the above described target container revolving conveyer device. This means that the source containers are in this case identical to the target containers and that the source container revolving conveyer device is structured and dimensioned in accordance with the target container revolving conveyer device. This also allows a space saving and cost efficient modular or construction kit structure for the invention, wherein the (target and source) container revolving conveyer devices can be selectively used both as target container revolving conveyer devices and as source container revolving conveyer devices, and wherein the target containers as such can be used as source containers and the other way round. Thus, since all container revolving conveyer devices in this case are formed as modules identical to each other, sorting devices of different dimensions can be provided in a cost efficient manner. There may be one or two source container revolving conveyer devices arranged centrally and there may be respectively one or two target container revolving conveyer devices arranged, when seen in horizontal direction, on both outer sides of the centrally arranged source container revolving conveying device(s). There may also be source container revolving conveying devices and target container revolving conveying devices arranged in an alternated manner. The supply of source containers to the respective source container revolving conveyer device is achieved by means of the source container conveyer installation which may be structured in accordance with the target container conveyer installation. That is, the source container conveyer installation may be provided as a gripper device and/or as transport path device with one or a plurality of transport belts. The supply/return transport paths of the target container conveyer installation(s) may simultaneously serve as supply/return transport paths of the source container conveyer installation. The source container conveyer installation may additionally comprise one or more storage access apparatuses, for example a storage and retrieval unit or a storage and retrieval vehicle for accessing the source containers stored in the article storage and for supplying the source containers to the further transport installations of the conveyer technique for supplying the source containers to the source container revolving conveyer device(s).

The respective target container revolving conveyer devices and/or the respective source container revolving conveyer devices which are provided as modules, are, for example connected to each other in a manner to be movable relative to each other in a guided manner of a drawer type, for example, by means of engaged guiding rails and longitudinal grooves including sliding or roller bearings. The guiding axis, for example, extends substantially horizontally and parallel to the upper and lower conveying paths. However, also plug connections between the modules are possible, wherein the respective modules are connected to each other in a plugged or snap-fit manner in a direction transverse to the conveying circuit planes. The drawer system would have the effect that centrally arranged modules would be more easily replaceable by means of drawing out the respective module and sliding back the module into the module combination block.

The respective target container revolving conveyer device may have as substantially horizontal conveying paths, for example, two roller paths or two roller supported transport belts with freely rotating and/or motor driven rollers, onto which the target containers can be directly placed. The lift devices may be gripper arms which can grip the target containers at the front end of the conveying circuit and may freely transfer the target containers. The lift devices may also be lift platforms which can be brought in alignment to the respective conveying path so that the conveying path can directly convey the containers onto the platform. There may also be carrying means fixedly integrated in the conveying circuit, such as carrying plates, on which the target containers can be placed. The carrying plates may be continuously transported in a revolving manner, for example via roller paths in the substantially horizontal, wherein at the end of the respective strand, that is at the end of the respective substantially horizontal conveying path, the carrying plates roll or are shifted onto a lift device in order to be lifted or lowered to the conveying path above or bellow, respectively, where the carrying plates then are shifted from the lifting device to this other conveying path.

According to an embodiment, the target container revolving conveyer devices and/or a plurality of source container revolving conveying devices are arranged adjacent to each other in a row, with their conveying circuit planes extending in parallel to each other, wherein the target container revolving conveyer devices and/or the source container revolving conveyer devices, for example, are horizontally arranged offset to each other along their conveying circuit planes so that, when seen in top view they, they describe an upside down V-shape facing the sorting area, or wherein, for example, the target container revolving conveyer devices and/or the source container revolving conveyer devices are arranged with their conveying circuit planes at an angle, for example an angle of 90°, extending toward to each other.

The target container conveying circuit of the respective target container revolving conveyer device and/or the source container conveying circuit of the respective source container revolving conveyer device may, for example, comprise two linear conveying paths which are arranged in a vertical distance to each other and which extend, for example, parallel to each other, with a respective drive means for automatically moving the target containers and the source containers, respectively, and may comprise, at the ends of the linear conveying paths, respectively a lift device for automatically transferring the target containers and the source containers, respectively, from the one linear conveying path to the respective other linear conveying path. The drive means of the lower linear conveying path is, for example, provided as a gravity drive, and the drive means of the upper linear conveying path is, for example, provided as an electric motor drive

According to an embodiment, a plurality of, for example at least four, at least five or at least six, target containers and source containers, respectively, are circularly conveyable in the respective target container revolving conveyer device and/or in the respective source container revolving conveyer device.

### IV. BRIEF DESCRIPTION OF DRAWINGS

The drawings are not necessarily to scale, emphasis instead generally being placed upon illustrating the principles of the invention. In the following description, various embodiments of the invention are described with reference to the following drawings, in which:

FIG. 1 shows a perspective schematic diagram of a sorting device according to an embodiment of the invention.

FIGS. 2 and 3 show a schematic top view and a schematic side view, respectively, of a sorting device according to an embodiment of the invention.

FIG. 4 shows a schematic side view of a module of a sorting device according to an embodiment of the invention.

FIG. 5 shows a schematic side view of a module of a sorting device according to an embodiment of the invention.

FIG. 6 shows a schematic side view of a module of a sorting device according to an embodiment of the invention.

FIG. 7 shows a perspective schematic view of an embodiment of a sorting device according to the invention.

FIG. 8 shows a schematic view of an operating panel of the sorting device according to an embodiment of the invention.

FIGS. 9-12 show schematic top views of further embodiments of the invention.

### V. DETAILED DESCRIPTION OF THE DRAWINGS

In the following the invention will be explained on the basis of several embodiments with reference to the attached drawings.

In the figures similar referenced signs are used for similar elements.

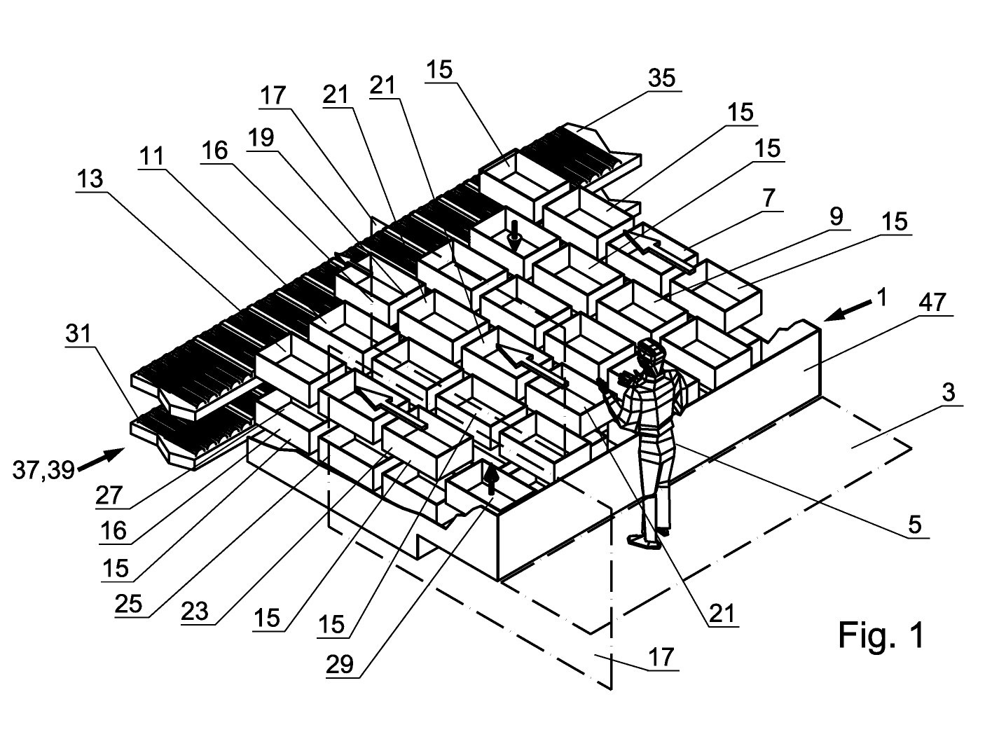

FIG. 1 shows a sorting device 1 according to an embodiment of the invention, comprising a sorting area 3 provided as a horizontal elongate standing surface, in which a sorting person 5 is located, and comprising four target container revolving conveyer devices 7, 9, 11, 13 which are arranged parallel to each other and which, with their front end sides, abut on the sorting area 3 and in which respectively seven box-shaped target containers 15 are provided in a manner to vertically revolve in a conveying circuit 16, that is, in a conveying loop 16. The respective conveying circuit extends in a respective vertical conveying circuit plane 17. Centrally arranged between the target container revolving conveyer devices 7, 9, 11, 13, there is arranged a source container revolving conveyer device 19, in which seven box-shaped source containers 21 vertically revolve in a conveying circuit 16 in a vertical conveying circuit plane 17. The vertical conveying circuit planes 16 of the target container revolving conveyer devices 7, 9, 11, 13 and of the source container revolving conveyer device 19 extend parallel to each other.

The respective target container revolving conveyer devices 7, 9, 11, 13 and source container revolving conveyer device 19 are identical in structure/construction, with identical containers 15, 21, so that the source containers 21 may also be used as target containers 15 and the other way round. Further, any of the target container revolving conveyer devices 7, 9, 11, 13 may be used as a source container revolving conveyer device and the source container revolving conveyer device 19 may be used as a target container revolving conveyer device.

The sorting area 3 extends, at its front end side, immediately adjacent and in front of the container revolving conveyer devices 7, 9, 11, 13 and 19 with a length corresponding to the overall width of the container revolving conveying devices 7, 9, 11, 13 and 19. The respective conveying circuit plane 17 crosses the sorting area 3 so that the sorting area 3 and the sorting person 5 located therein are positioned at the front end side of the respective conveying circuit 16, at which position also a turning location (U-turn location) of each of the container revolving conveyer devices 7, 9, 11, 13 and 19 is provided. The respective target containers 15 and the respective source containers 21, for example, have dimensions of 600 mm×400 mm×220 mm (length×width×height). The width of the respective container revolving conveyer device 7, 9, 11, 13 and 19 is, for example, 500 mm so that the overall width of the container revolving conveyer devices 7, 9, 11, 13 and 19 and, thus, the length of the sorting area 3 is about 2500 mm.

Since the container revolving conveyer devices 7, 9, 11, 13 and 19 are identical to each other in construction they form modules which can be replaced by each other in an easy manner. Also, further such modules may easily be added or removed. The modules are connected to each other in a kit-type manner, for example by means of longitudinal guide devices which extend substantially horizontally and parallel to the supply and return directions (see below) of the container revolving conveyer devices 7, 9, 11, 13 and 19.

In the following, only the target container revolving conveyer device 13 on the left-most side in FIG. 1 is described in further detail. This detailed description also applies for the other target and source container revolving conveyer devices.

The target container revolving conveyer device 13 comprises an upper conveying path 23 which extends substantially linearly and which is provided as a return strand, on which target containers 15 are carried away or returned from the sorting area 3. The upper conveying path 23 extends at such a height level that the target containers 15 conveyed thereby are in a working level height of approximately 1100 mm. That target container 15 of the upper conveying path 23, which is closest to the sorting area 3, is the target container 15 which is presently or actually to be loaded by the sorting person 5. The target container revolving conveyer device 13 further has a lower substantially horizontally and substantially linearly extending conveying path 25, which is provided as a supply strand and on which the target containers are supplied to the sorting area 3 vertically below the return strand.

Thus, the target containers 15 (and correspondingly the source containers 21) are conveyed in the lower conveying path in a substantially horizontal manner towards the sorting area 3 and towards the sorting person 5, and the target containers 15 (and correspondingly the source containers 21) in the upper conveying path 23 are conveyed in a substantially horizontal manner away from the sorting area 3 and from the sorting person 5. As an alternative, target containers 15 (and source containers) may also be conveyed towards the sorting area 3 on the upper conveying path 23 and may be conveyed away from the sorting area 3 on the lower conveying path 25. There may also be a reverse operation of the respective two conveying paths.

A first turning location 27, which is remote from the sorting area 3, in the conveying circuit of the target container revolving conveyer device 13 is provided with a lift device (not shown), by which target containers 15 are automatically, for example by means of an electric motor drive, transferrable from the upper conveying path 23 (return strand) to the lower conveying path 25 (supply strand) for maintaining the revolving operation. The second turning location 29, which faces the sorting area 3, in the conveying circuit in the target container revolving conveyer device 13 is also provided with a lift device (not shown), which is, for example, identical in construction with the firstly-mentioned lift device, to automatically, for example via an electric motor drive, transfer the target containers 15 from the lower conveying path 25 (supply strand) to the upper conveying path 25 (return strand) for maintaining the revolving operation. The lift device at the front-end side facing the sorting person 5 may also be omitted, and the container may be manually transferred from the supply strand to the return strand. The target containers 15 may be driven via an electric motor on the upper as well as on the lower conveying paths 23, 25. The whole revolving conveying operation may also be reversible in conveying direction.

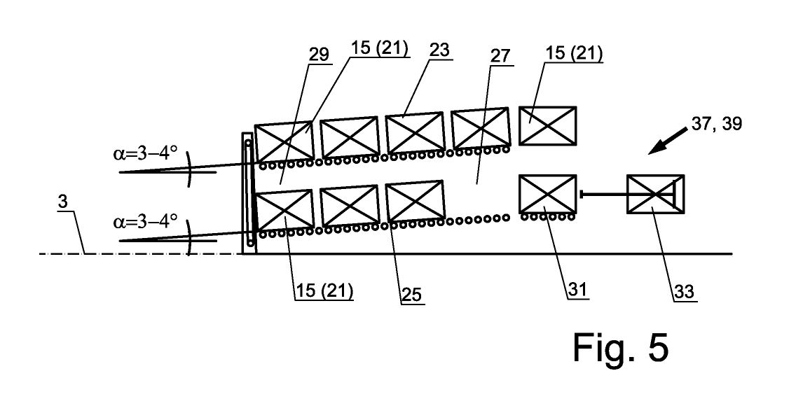

FIG. 5 shows an embodiment of a target container (or of a source container) revolving conveyer device 13 (19), wherein the upper and the lower conveying paths 23, 25 between the first and the second turning locations 27, 29 are inclined towards the sorting area 3 at a predetermined angle, for example 3°-4° or 5°. (However, such an inclination is still considered to be substantially horizontal.) Due to the inclination, the lower conveying path 25 is provided with a gravity drive means driving towards the sorting area 3 so that a motor drive may be omitted. However, the upper conveying path 23 has to be provided with a drive, for example an electric motor drive, for overcoming the gravity in order to carry away the target containers 15 (or the source containers 21) from the sorting area 3. Such a drive means on the upper conveying path 23 may also be provided by manual force. That is, the sorting person may shift back the abutting target containers 15 along their upper conveying path 23, which is, for example, a roller transport path. As another example, the upper conveying path 23 is provided with a motor drive, for example with an electric motor drive, to return the target containers 15 from the sorting area 3. It is also possible that the upper conveying path 23 is inclined at a predetermined angle away from the sorting area 3, for example at an angle of 3°-4° or 5° so that the target containers 15 are also returned via gravity from the sorting area 3.

The supply of empty or partially loaded target containers 15 to the respective target container revolving conveying device 7, 9, 11, 13 may be provided in accordance with the embodiments of FIG. 1 and FIG. 5 by means of a lower roller transport path 31 which extends at the level of the lower conveying path 25 of the respective target container revolving conveyer device 7, 9, 11, 13 as well as adjacent to the turn location 27 thereof remote from the sorting area 3 at the corresponding front-end side thereof. Therefore, for example by means of a shifting device, such as a pressure operated, for example hydraulic or pneumatic, shifting cylinder, a target container 15 may be directly transferred from the lower roller transport path 31 to the respective target container revolving conveyer device 7, 9, 11, 13, that is, can be shifted onto the lower conveying path 23 thereof. The return of completely or partially loaded target containers from the respective target container revolving conveyer device 7, 9, 11, 13 may be provided by means of an upper roller transport path 35 which extends in parallel and in a vertical distance to the lower roller transport path 31. The transfer of the respective target container 15 from the upper conveying path 25 to the upper roller transport path 35 may be provided, for example, by the drive of the upper conveying path 25. In this case, when using gravity drive, a mechanical stopper may be provided, which prevents the target container 15 from accidently moving from the target container revolving conveyer circuit 16 to the upper roller transport path 35. In accordance with the embodiments of FIGS. 1 and 5, the upper and the lower transport paths 31 and 35 form a target container conveyer installation 37 for supplying and returning target containers 15 to and from, respectively, the respective target container revolving conveyer device 7, 9, 11, 13. And the target container supply conveyer installation 37, that is the transport paths 31, 35 thereof, extend transverse to the conveying circuit planes 17.

It is possible with each target container revolving conveyer device 7, 9, 11, 13 to load the respective target container 15 only with a certain article and then convey back this target container 15 via return operation of the target container revolving conveyer device 7, 9, 11, 13 to the lower roller transport path 31 in order to transfer the target container 15 from this location to another target container revolving conveyer device 7, 9, 11, 13 for being further loaded. Such a target container 15 partially loaded as described above and transported to the upper roller transport path 35 may also be transferred, via a shifting device as described above, from the upper roller transport path 35 to the upper conveying path of another one of the target container revolving conveyer devices 7, 9, 11, 13 where the target container will be further loaded, which upper conveying path hereunto temporarily works as a supply path (i.e., in a reverse direction).

The target container conveyer installation 37 of the sorting installation 1 according to the embodiments of FIGS. 1 and 5 may also be simultaneously used as a source container conveyer installation 39 for correspondingly supplying and returning source containers 21 to and from the centrally arranged source container revolving conveyer device 19. Source containers 21 may be transported to the source container conveyer installation 39 from an article storage (not shown), for example from a stack storage, by means of, for example, an article storage and retrieval unit and are transported by the source container conveyer installation 39 to the respective source container revolving conveyer device 19 to be inserted into that source container revolving conveyer device 19, that is, into the conveying circuit 16 thereof, to be finally supplied to the sorting person 5 in the sorting area 3 by the source container revolving conveyer device 19 in a revolving and repeated manner.

Instead of transport roller paths 31, 35 any other appropriate transport installations, for example carriages or storage and retrieval units, may be used as the target container conveyer installation 37 and as the source container conveyer installation 39. Also, the roller paths 31, 35 may, for example, be replaced by conveying belts. A respective article storage and retrieval unit for a high-bay warehouse may also be directly assigned to the respective sorting installation 1, wherein the storage and retrieval unit may directly grip, that is, without intermediate transport path, respective source containers from the storage and may place them directly on the source container revolving conveyer device 19 as well as may directly take away the source containers therefrom. The same may apply for the transfer of target containers between the target container revolving conveyer devices 7, 9, 11, 13 and empty target container storage and/or between the target container revolving conveyer devices 7, 9, 11, 13 and a storage for completely loaded target containers.

The operation of the sorting installation 1 may, for example, be as follows: target containers 15 are supplied to the respective target container revolving conveyer device 7, 9, 11, 13 by the target container conveyer installation 37 until the respective target container revolving conveyer device 7, 9, 11, 13 is respectively and completely loaded with seven target containers 15 which are initially empty. In this respect, it is however not necessary to completely load the target container revolving conveyer device 7, 9, 11, 13 with target containers 15. The sorting process may also already start when the first container 15 is positioned in a front upper position. That is, said container is positioned at a location facing the sorting area 3 and is accessible to the sorting person. Simultaneously, the source container conveyer installation 39 conveys source containers 21 from an article storage to the source container revolving conveyer device 19. In this case, it may be for example recognized by a sensor device, how many articles are available in a respective source container. If the number of available articles is smaller than the number of articles required in the respective target container revolving conveyer device, in which the said source container is applied, then, for example, a plurality of source containers may be input/supplied right after another into/to the respective source container revolving conveyer device 19.

The sorting person 5 may then sort, in accordance with a desired sorting plan which is indicated on a corresponding display device, articles from the source containers 21 revolving in the source container revolving conveyer device 19 into the target containers 15 revolving in the four target container revolving conveyer devices 7, 9, 11, 13. For example, the display indicates at the source container revolving conveyer device 19 the number and the type of the articles to be taken out from the source container 21 currently accessible to the sorting person 5. (The indication of the article type may be omitted, if only one article type is available in the respective source container.) The display may further, for example, indicate at the respective target container revolving conveyer device the number of the articles to be input/loaded into the target container 15 which is there currently accessible to the sorting person 5.

For example all (in this case seven) target containers of the respective target container revolving conveyer device 7, 9, 11, 13 are loaded with one or with a plurality of articles from the source container 21 (or if the reservoir of this source container is not sufficient the articles of the same type from a further source container), whereupon the next source container 21 with articles of another type is supplied thereto. In this way, for example, all target containers 15 in each target container revolving conveyer device 7, 9, 11, 13 will be completely loaded, that is, will be loaded with all desired articles from diverse source containers 21 in the required number and are then transferred to the target container conveyer installation 37 in order to be forwarded by said target container conveyer installation 37 to, for example, a final shipment completion.

Alternatively, the target containers 15 in the respective target container revolving conveyer device 7, 9, 11, 13 may only be loaded with articles of a single type or with a number smaller than the finally desired number of article types. Then the respective target containers 15 may then be transferred to a next one of the target container revolving conveyer devices 7, 9, 11, 13 or alternatively to a next sorting installation 1 according to the invention to be further loaded there, wherein such a process may be repeated until the respective target container 15 is completely loaded.

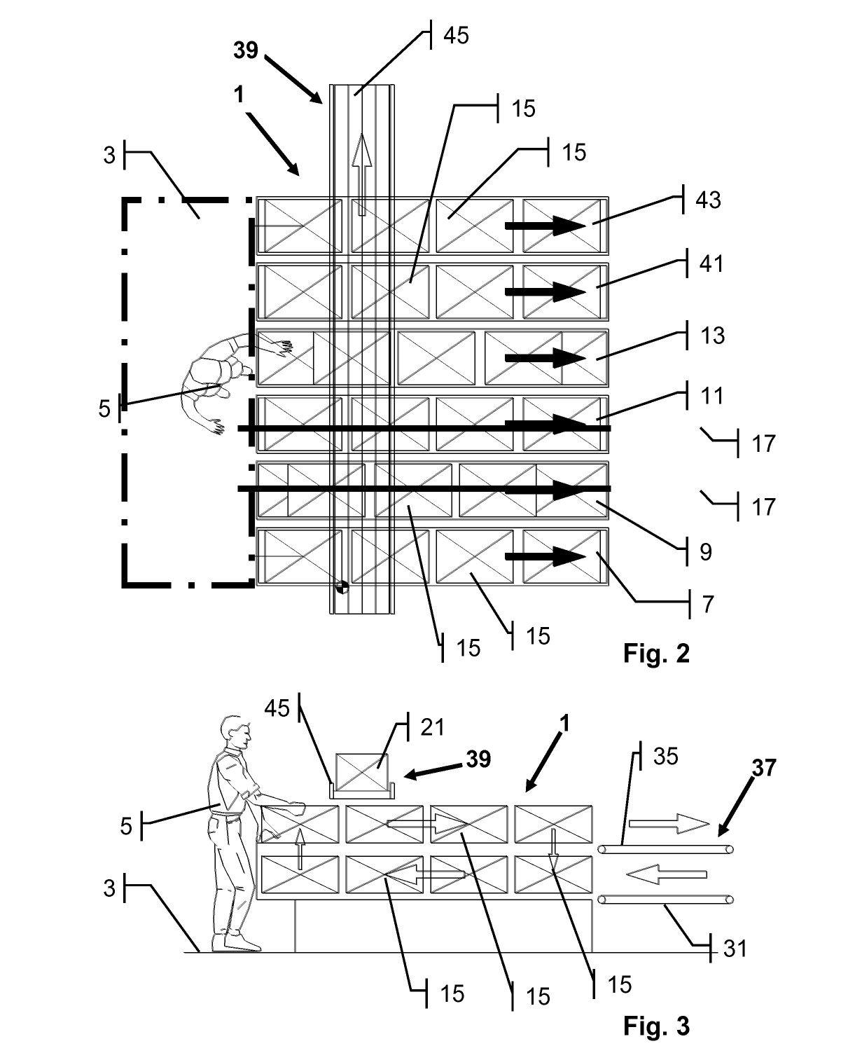

FIGS. 2 and 3 show an alternative embodiment of a sorting installation 1 according to the invention. In this embodiment, six target container revolving conveyer devices 7, 9, 11, 13, 41, 43 are modularly arranged parallel to each other in a row and abut at their front-end sides on a sorting area 3, in which a sorting person 5 is located. The conveying circuit planes 17 thereby extend vertically and parallel to each other and transverse to the sorting area 3. The target container revolving conveyer devices 7, 9, 11, 13, 41, 43 are substantially structured in accordance with those according to FIGS. 1 and 5 so that the detailed description thereof is omitted. The difference consists in that now eight target containers 15 can revolve in the respective target container revolving conveyer device 9, 11, 13, 41, 43. At the front-end of the target container revolving conveyer devices 7, 9, 11, 13, 41, 43 facing away from the sorting area 3 there is again arranged a target container conveyer installation 37 with upper and lower conveyer paths 35, 31 for carrying away and supplying, respectively, target containers 15 from and to the respective target container revolving conveyer device 7, 9, 11, 13, 41, 43.

Further, in contrast to the embodiment of FIGS. 1 and 5, in the embodiment according to FIGS. 2 and 3, the source container conveyer installation 39 comprises a source container conveyer path 45 which extends cross-wise over the target container revolving conveyer devices 7, 9, 11, 13, 41, 43 and which thereby extends transverse to the conveying circuit planes 17 of the conveying circuits 16 of the target container revolving conveyer devices 7, 9, 11, 13, 41, 43. The source container conveyer path 45 conveys source containers 21 directly adjacent to the sorting area 3 so that the sorting person 5 can directly take out articles from the source containers 21 positioned on the source container conveyer path 45. The source container conveyer path 45 in turn can be provided as a circular conveyer and can extend across all of a plurality of sorting installations 1 in the above-described manner.

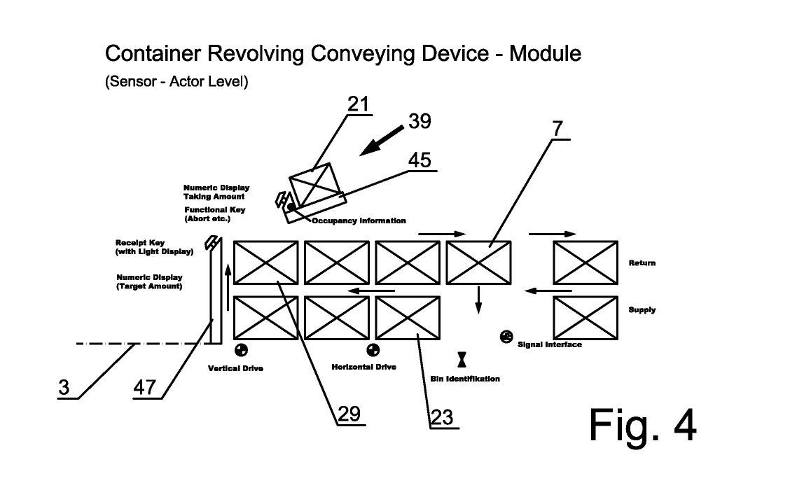

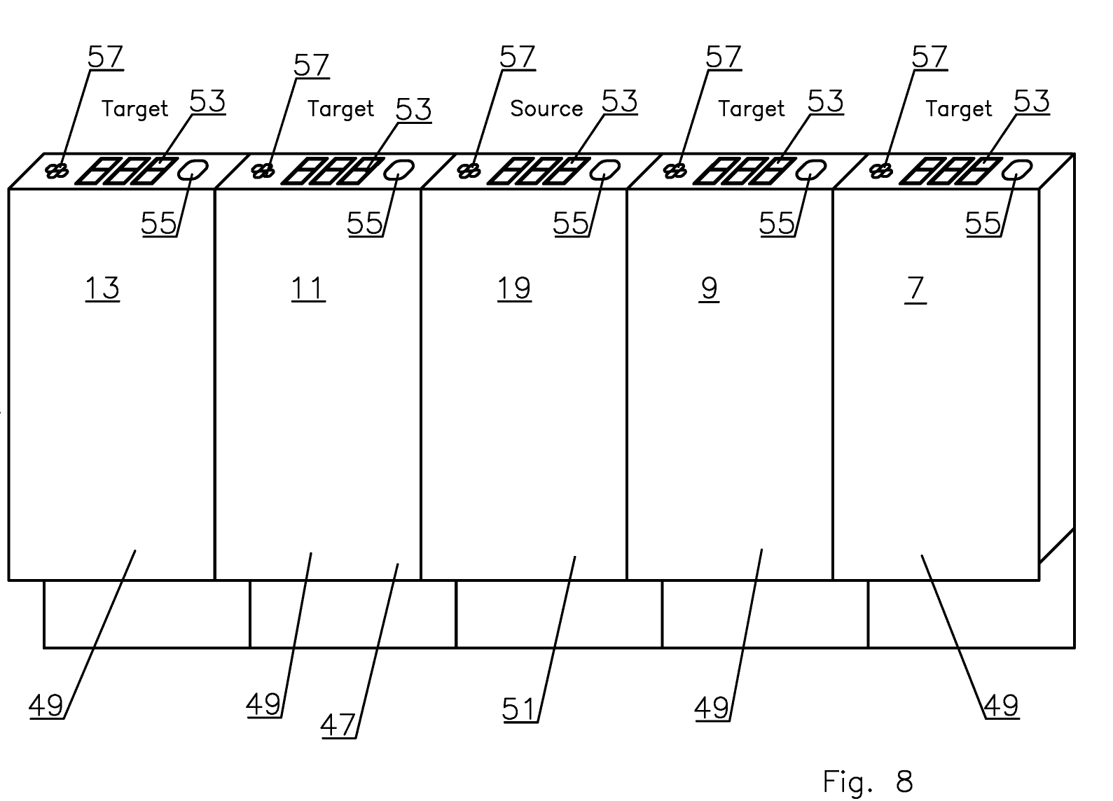

FIG. 4 shows schematically a target container revolving conveyer device 7 of a sorting installation 1 according to an embodiment of the invention, which is provided as a module. This embodiment is similar to that shown in FIGS. 2 and 3, wherein, however, the source container conveyer path 45 is tilted towards the sorting area 3 so that the sorting person 5 has easier access to the content in the respective source containers 21. The source container conveyer installation 37 is also schematically shown. In FIG. 4 there are also shown diverse drive means for the revolving operation. In this respect, a vertical motor drive is provided on the turning location 29 facing the sorting area 3, and a horizontal motor drive is provided on the lower conveyer path 25. Further, diverse sensors for monitoring the occupancy and the further operation of the source container revolving conveyer devices 7, 9, 11, 13, 41, 43 and of the source container revolving conveyer device 45 and of the target container conveyer installation 37 and of the source container conveyer installation 39 are provided. An operation panel 47 is arranged on the front-end side at the turn location 29 facing the sorting area 3. The operation panel 47 can, for example, be structured as shown in FIG. 8.

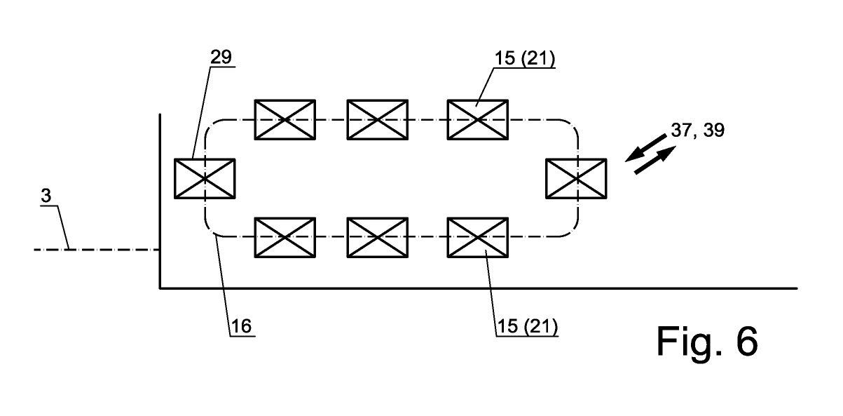

FIG. 6 shows schematically another revolving principle for the target containers and/or for the source containers 15, 21 as alternative to the shifting/lifting principle according to FIGS. 1-5. That is, the containers 15, 21 in this case are transported according to the paternoster principle and are suspended in a revolving strand, whereby only drive means for driving the strand may be required and the lifting devices may be omitted. The container 15, 21 that is located on the left side turning locations 29 in FIG. 6 can be accessed, for loading and/or unloading, by a sorting person standing at the front-end side of the conveying circuit 16 in the sorting area 3. The containers 15, 21 can be inserted into the paternoster and can be taken off therefrom at the right side turning location 27 in FIG. 6 by means of a mechanism.

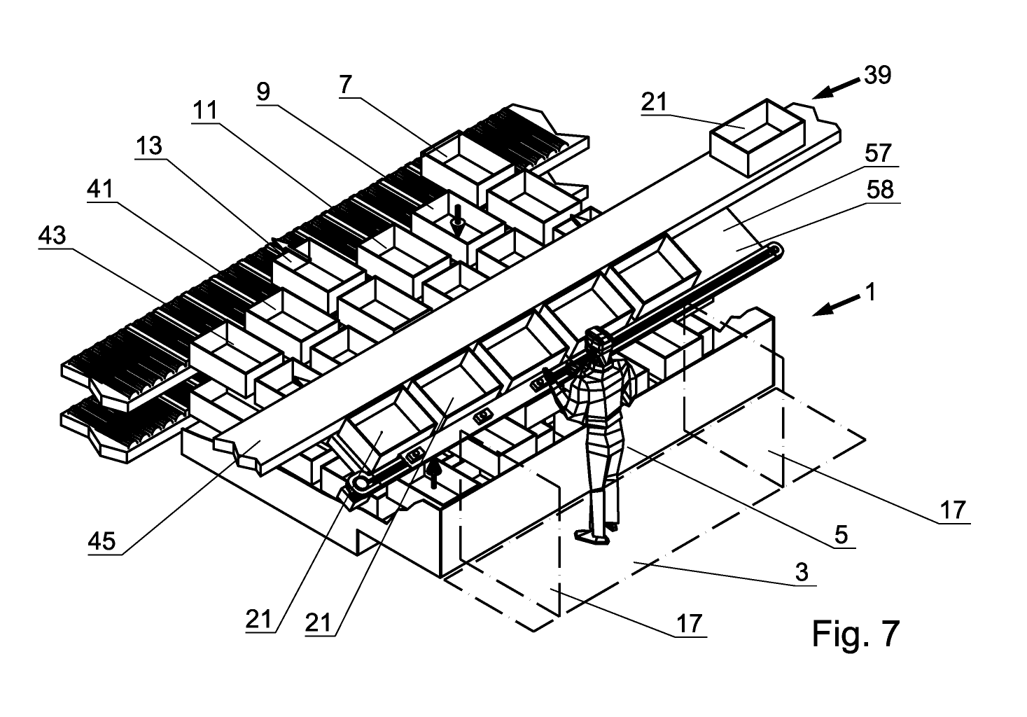

The sorting installation 1 shown in FIG. 7 is substantially structured in a manner as that shown in FIGS. 2 and 3 so that regarding its general structure it is referred to the above description as to FIGS. 2 and 3. One difference can be seen in that the sorting installation 1 according to FIG. 7 comprises a tilting mechanism 57, by means of which the source containers 21 which are supplied by the transport path 45 source container conveyer installation to the sorting area 3 are tilted onto an inclined surface 58 which is sloped towards the sorting area 3 and thereby towards the sorting person 5 so that the sorting person 5 has a better access to the articles in the source containers 21. The inclined surface 58 extends, with its longitudinal direction, cross-wise over all target container revolving conveyer devices 7, 9, 11, 13, 41, 43 and thereby transverse to the conveying circuit planes 17 thereof. Thereby, the sorting person 5 has simultaneous access to several source containers 21.

FIG. 8 shows an embodiment of an operation panel 47, as, for example, for a sorting installation 1 according to the embodiment of FIG. 1 (see, for example, schematically shown operation panel 47 in FIG. 1). The operation panel 47 according to this embodiment comprises four target operation units 49 which are assigned to a respective one of the target container revolving conveyer devices 7, 9, 11, 13, wherein the respective target operation unit 49 is positioned at the front-end side of the respectively assigned target container revolving conveyer device 7, 9, 11, 13 in a manner aligned therewith and is facing the sorting area 3. In a central position there is arranged a source operation unit 51 which is assigned to the source container revolving conveyer device 19 and which therefore, corresponding to the target operation units, forms a front-end completion of the source container revolving conveyer device 19.

The respective operation unit 49, 51 has a display 53 which in the target operation units 49 may indicate the number of articles which are to be transferred from the source container currently available at the source container revolving conveyer device 19 into the respective target container currently available at the respective target container revolving conveyer device 7, 9, 11, 13. The display 53 of the source operation unit may indicate how many articles have to be transferred from the source container currently available into the target containers currently available. The term “currently available” means in this case that the sorting person (currently) has access to this container.

It may be required that a respective receipt key 55 is to be applied if the target number of articles is input into the respective target container and/or is taken out of the respective source container. Further each operation unit may have an amount correction operation field 54 for deficit and/or excess amounts, by means of which the revolving operation of the respective container revolving conveyer device 7, 9, 11, 13, 19 may also be manually controlled. For example, the revolving direction can thereby be controlled and/or the revolving operation can be started and can be stopped again.

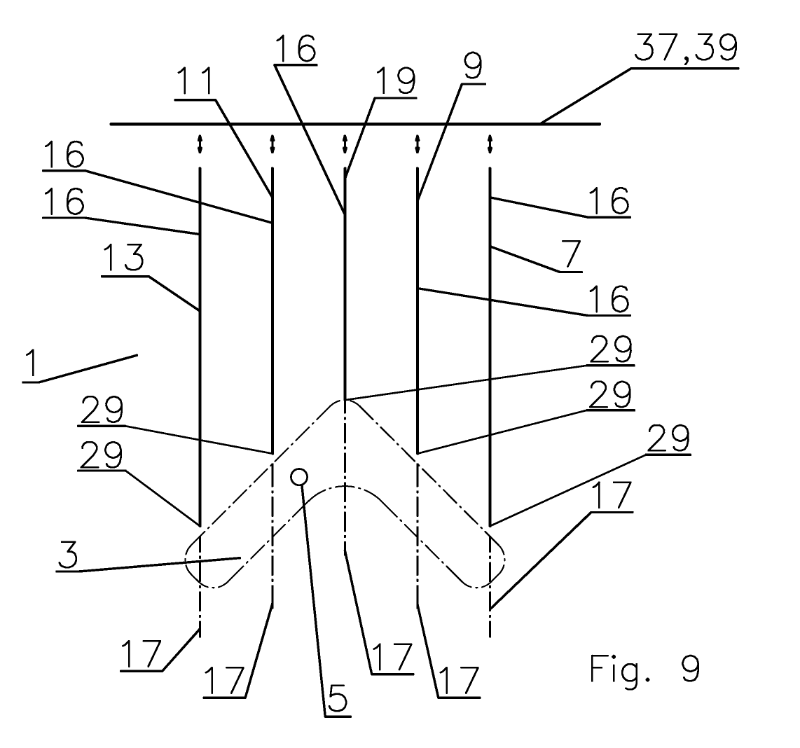

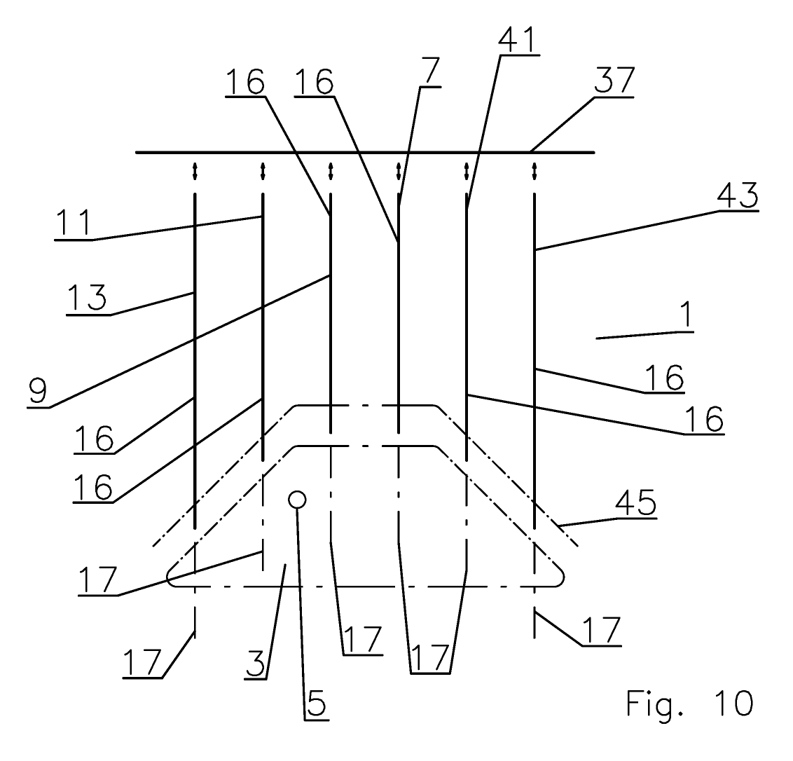

The embodiments shown in FIGS. 1, 2 and 7 of the sorting installation 1 according to the invention show their target container revolving conveyer devices 7, 9, 11, 13, 41, 43 and their source container revolving conveyer devices 19 in a manner so as to be aligned, at the front-end side facing the sorting area 3, in a direction perpendicular to the conveyer circuit planes 17. In this respect, FIGS. 9-12 show alternative embodiments of the invention.

For example, in the sorting installation 1 according to the embodiment of FIG. 9, four target container revolving conveyer devices 7, 9, 11, 13 and one source container revolving conveyer device 19 centrally arranged thereto extend parallel to each other with their conveyer circuit planes 17. However, the front-end sides of the respective conveyer circuits 16 facing the sorting area 3 are arranged offset relative to each other when seen in top view in a manner so that they form an upside down V-shape facing the sorting area 3, wherein in this case the conveyer circuit 16 of the source container revolving conveyer device 19 ends, with its front-end side, at the intersection of the V-legs. That is, said conveyer circuit 16, at that location, has its vertical turning location 29 facing the sorting area 3. And, the conveyer circuits 16 of the target container revolving conveyer devices 7, 9, 11, 13 end, with their front-end sides, in a respective symmetrical manner at the V-legs. That is, the vertical turning locations 29 thereof facing the sorting area 3 are located at the V-legs. Thus, in this embodiment a sorting person 5 has horizontal front-end side access to the source container which is positioned at the front-end side of the centrally arranged source container revolving conveyer device 19, and the sorting person 5 has further horizontal front-end side access as well as horizontal lateral access to the target containers which are positioned on the front-end side of the target container revolving conveyer devices 7, 9, 11, 13 which are arranged laterally with respect to the source container revolving conveyer device 19. All revolving conveyer devices 7, 9, 11, 13, 19 in turn convey towards the sorting area 3, wherein the source container revolving conveyer device directly and frontally conveys toward the sorting area 3, and wherein the target container revolving conveying devices convey in an angle (determined by the angle of the V-shape) towards the sorting area 3. For supplying and returning of target containers and source containers to and from the revolving conveyer devices 7, 9, 11, 13, 19 a transport device 37, 39 as schematically depicted may be used.

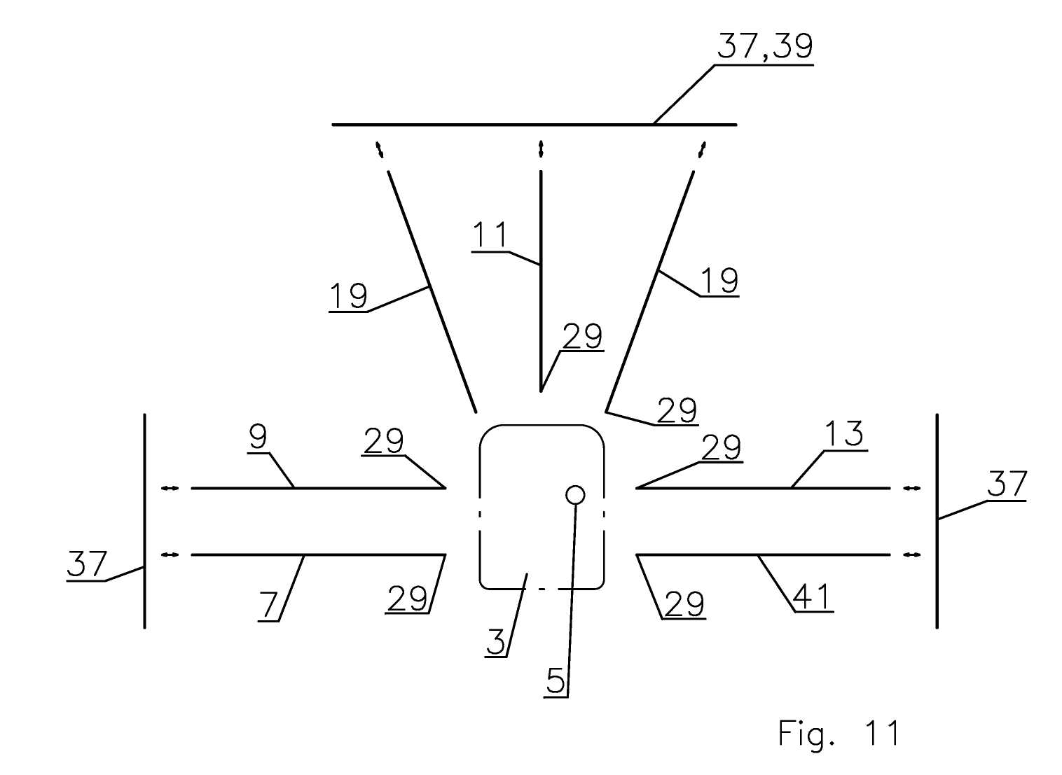

The embodiment of the sorting installation 1 according to FIG. 10, which provides an alternative to the embodiment according to FIG. 7, comprises a transport device 45 for supplying and returning source containers to/from the sorting area 3, which extends cross-wise over the six target container revolving conveyer devices 7, 9, 11, 13, 41, 43. The target container revolving conveying devices 7 and 9 are centrally arranged and, when seen in top view, end in an aligned manner at the sorting area 3 so that the assigned conveyer circuit planes 17 cross the sorting area 3 in a frontal manner. The target container revolving conveying devices 13, 9, 41 and 43 arranged on the lateral outer sides of centrally arranged ones end, when seen in top view, at the sorting area 3 in such an offset manner, that an upside down V-shape facing the sorting area 3 is provided. The sorting area 3, thus, extends, when seen in top view (corresponding to the embodiment of FIG. 9), along a V-shape (defined by the frontal ends of the conveyer circuit 16 of the target container revolving conveyer devices 7, 9, 11, 13, 19, 41, 43) so that the conveyer circuit planes 17 of the four laterally outer target container revolving conveyer devices 13, 9, 41, 43 cross the sorting area 3 in an inclined manner defined by the V-shape.

In this embodiment, the sorting person 5 located in the sorting area 3 therefore has horizontal frontal access to the target containers which are located on the front-end side of the centrally arranged target container revolving conveyer devices 7, 9 and further has horizontal frontal and horizontal lateral accesses to the target containers which are arranged on the front-end side of the laterally outside target container revolving conveyer devices 11, 13, 41, 43.

Further in this embodiment, the supply/return of target containers is achieved by means of a target container conveyer installation 37 which extends along the front-ends of the target container revolving conveyer devices 7, 9, 11, 13, 41, 43 facing away from the sorting area 3.

In the embodiment of the sorting installation 1 shown in FIG. 11 in top view in schematic, the target container and/or source container revolving conveyer devices 7, 9, 11, 13, 41, 19 convey in a fan-shaped manner towards the centrally arranged sorting area 3 and correspondingly convey away therefrom, wherein the supply/return of target containers/source containers thereto is achieved via conveyer installations 37, 39 which extend along the front-ends of the revolving conveying devices 7, 9, 11, 14, 41, 19 facing away from the sorting area 3. Also a star-shaped arrangement of the revolving conveyer devices 7, 9, 11, 14, 19, 43 with respect to the centrally arranged sorting area 3 is possible.

In this case, the sorting area 3, in which the sorting person 5 has access to the supplied containers for loading and/or unloading, always extends along the front-ends (vertical turning locations 29) of the revolving conveying devices 7, 9, 11, 13, 41 facing the sorting area 3 so that the (imaginary) vertical conveyer circuit planes 7 thereof extend through the sorting area 3.

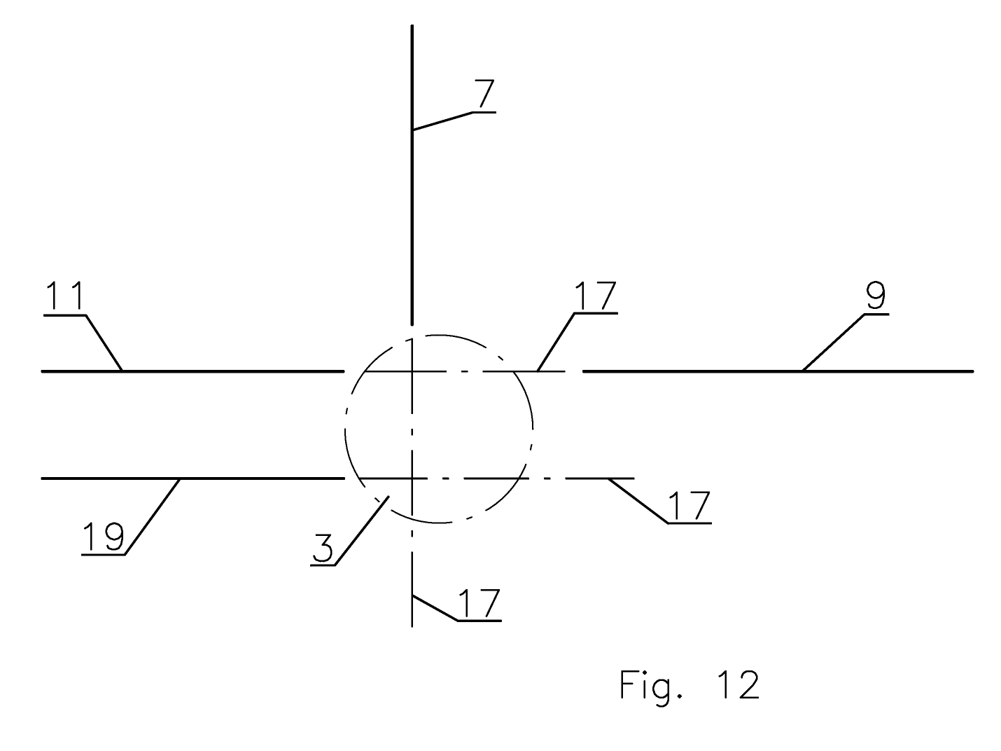

A further variant thereof is schematically depicted in top view in FIG. 12, wherein a first and a second target container revolving conveyer circuit 7, 9 extend, with their conveying circuit planes 17, perpendicular to each other, and a third target container revolving conveying circuit 11 and a source container revolving conveying circuit 19 extend parallel to each other as well as perpendicular to the first 7 as well as parallel and opposite to the second target container revolving conveying circuit 9. In this embodiment of the invention, the sorting area 3 extends centrally at the intersection of the conveying circuit planes 17 of the revolving conveying circuits 7, 9, 11, 19.

Further embodiments of the invention may be as follows:

According to a first further embodiment of the invention, a sorting installation 1 is provided, including a sorting area 3 for sorting articles from source containers 21 into target containers 15 by means of a sorting person 5 located in the sorting area, at least one target container revolving conveyer device 7, 9, 11, 13, 41, 43 which is located adjacent to the sorting area 3 and which is provided such that it supplies a plurality of target containers 15 along a target container conveying circuit 16 in a conveying circuit plane 17 to the sorting person 5 in the sorting area 3 in a revolving and repeated manner until the respective target container 15 is loaded with articles from one or several source containers 21 up to a pre-determined degree, for example completely, wherein the conveying circuit plane 17 of the target container conveying circuit 16 of the respective target container revolving conveying device 7, 9, 11, 13, 41, 43 substantially extends vertically and crosses the sorting area 3, and a target container conveyer installation 37 for supplying and returning target containers 15 to/from the at least one target container revolving conveyer device 7, 9, 11, 13, 41, 43.

According to a second further embodiment of the invention, the sorting installation according to the first further embodiment is at least further provided with a source container revolving conveyer device 19 located adjacent to the sorting area 3 and which is provided such that it supplies a plurality of source containers 21 along a source container conveying circuit 16 in a conveying circuit plane 17 to the sorting person 5 in the sorting area 3 in a revolving and repeated manner until a predetermined number of articles, for example all articles, are sorted from the respective source container 21 into the target containers 15, and a source container conveyor installation 39 provided for supplying and returning source containers 21 to/from the at least one source container revolving conveyer device 19, wherein the conveying circuit plane 17 of the source container conveying circuit 16 of the respective source container revolving conveyer device 19 extends vertically and crosses the sorting area 3.

According to a third further embodiment of the invention, in the sorting installation 1 according to the first further or according to the second further embodiment, a plurality of target container revolving conveyer devices 7, 9, 11, 13, 41, 43 and/or a plurality of source container revolving conveyer devices 19 are arranged in a row adjacent to each other with their conveying circuit planes 17 extending parallel to each other.

According to a fourth further embodiment of the invention, in the sorting installation according to any one of the second to third further embodiments, the target container revolving conveyer device(s) 7, 9, 11, 13, 41, 43 and/or the source container revolving conveyer device(s) 19 are provided as modules identical to each other, so that they can be connected in any order in a row adjacent to each other and/or can be replaced by each other in an arbitrary manner.

According to a fifth further embodiment of the invention, in the sorting installation according to any one of the second to fourth further embodiments, the target containers 15 are identical to the source containers 21.

According to a sixth further embodiment of the invention, in the sorting installation according to any one of the second to fifth further embodiments, the target container revolving conveyer device(s) 7, 9, 11, 13, 41, 43 and/or the source container revolving device(s) 19, for example in moving direction of the supply and return strands of the target container/source container conveying circuits 16, can be attached to each other and released from each other in a linearly guided manner.

According to a seventh further embodiment of the invention, in the sorting installation 1 according to any one of the previous further embodiments, the target container conveying circuit 16 of the respective target container revolving conveyer device 7, 9, 11, 13, 41, 43 and/or the source container conveyer circuit 16 of the respective source container revolving conveyer device 19 is provided with two linear conveying paths 23, 25 which are arranged at a vertical distance from each other and, for example, parallel to each other, and which have a respective drive means for automatically moving the target containers 15 and the source containers 21, respectively, and is further provided at the ends of the linear conveying paths 23, 26 with a respective lift device for automatically transferring the target containers 15 and the source containers 21, respectively, from the one to the respective other linear conveying path 23, 25.

According to an eighth further embodiment of the invention, in the sorting installation 1 according to the seventh further embodiment, the drive means of the lower linear conveyor path 25 is provided as gravity drive means and the drive means of the upper linear conveying path 23 is provided as an electric motor drive.

According to a ninth further embodiment of the invention, in the sorting installation 1 according to any one of the previous further embodiments, the respective target container revolving conveyer device 7, 9, 11, 13, 41, 43 and/or the respective source container revolving conveyer device 19 comprises several carrying means, such as for example carrying plates, which are fixedly provided in the respective target container conveying circuit 16 and in the respective source container conveying circuit 16, respectively, and revolve therewith for receiving and carrying target containers 15 and source containers 21, respectively, thereon.

According to a tenth further embodiment of the invention, in the sorting installation according to any one of the previous embodiments, there are a plurality of target containers 15 and source containers 21, respectively, for example at least four or at least six target containers and source containers, respectively, circularly conveyable in the respective target container revolving conveyer device 7, 9, 11, 13, 41, 43 and/or in the respective source container revolving conveyer device 19

According to an eleventh further embodiment of the invention, there is provided a method for sorting articles from source containers 21 into target containers 15 by a sorting person 5 being in a sorting area 3, for example by using the sorting installation 1 as described above, wherein a source container 21 with articles assigned to this source container 21 is automatically supplied to the sorting person 5, wherein a plurality of target containers 15, for example at least four or at least five or at least six target containers, are supplied to the sorting person 5 in the sorting area 3 in a revolving and repeating manner by at least one target container revolving conveyer device 7, 9, 11, 13, 41, 43, which is located adjacent to the sorting area 3, until the respective target container 15 which is revolving, is loaded with the articles from the supplied source container 21 in the desired number/amount.

According to a twelfth further embodiment of the invention, in the method according to the eleventh further embodiment, then another source container 21 with other articles assigned to this source container 21 is supplied to the sorting person 5 for sorting these articles into the respective revolving target container 15, wherein the target containers 15 remain revolving in the target container revolving conveyer device until they are loaded with a desired article in the respectively desired number, for example completely loaded, in order to be then returned from the target container revolving conveyer device 7, 9, 11, 13, 41, 43 by means of a target container conveyer installation 37.

According to a thirteenth further embodiment of the invention, in the method according to the eleventh or the twelfth further embodiment, if the supplied source container 21 becomes empty before the respective target container 15 is loaded with the articles of the source container 21 which has become empty in the desired number, another source container 21 with articles assigned to this source container 21, which are identical to those of the empty source container 21, is supplied to the sorting person 5.

According to a fourteenth further embodiment of the invention, in the method according to any one of the eleventh to thirteenth further embodiments of the invention, by means of at least one source container revolving conveyer device 19, which is located adjacent to the sorting area 3, a plurality, for example at least four or at least five or at least six, source containers 21 are supplied to the sorting person 5 in a revolving and repeated manner until a predetermined number of articles, for example all articles, are sorted from the respective source container 21 into the target container 15, wherein by means of a source container conveyer installation 39 the source containers 21 are supplied to/returned from the at least one source container revolving conveyer device 19.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. Sorting installation comprising
a sorting area for sorting articles from source containers into target containers by a sorting person in a sorting area,
a plurality of target container revolving conveying devices adjacent to the sorting area, each supplying a plurality of target containers along a target container conveying circuit in a conveying circuit plane to the sorting person in the sorting area in a repeated and revolving manner until the respective target container is loaded with articles from one or a plurality of source containers up to a predetermined degree, wherein the conveying circuit plane of the target container conveying circuit of the respective target container revolving conveyer device extends vertically and crosses the sorting area,
a target container conveying installation for supplying and returning target containers to and from the respective target container revolving conveyer device, and
a source container conveyer system for automatically conveying source containers from an article storage to the sorting area and for automatically returning source containers from the sorting area to the article storage.

2. The sorting installation according to claim 1, wherein the source container conveyer system comprises at least one source container revolving conveying device adjacent to the sorting area, which is provided such that it supplies a plurality of source containers along a source container conveying circuit in a conveying circuit plane to the sorting person in the sorting area in a repeated and revolving manner until a predetermined number of articles is sorted from the respective source container into the target containers, and
a source container conveyer installation for supplying and returning source containers to and from the at least one source container revolving conveyer device,
wherein the conveying circuit plane of the source container conveying circuit of the respective source container revolving conveyer device extends vertically and crosses the sorting area.

3. The sorting installation according to claim 2, wherein the target container revolving conveying devices and a plurality of source container revolving conveying devices are arranged in a row adjacent to each other with their conveying circuit planes extending parallel to each other.

4. The sorting installation according to claim 2, wherein the plurality of source container revolving conveying devices are arranged in a row adjacent to each other with their conveying circuit planes extending parallel to each other.

5. The sorting installation according to claim 2, wherein the target container revolving conveying devices are provided as modules identical to each other so that they can be arranged in a row and can be replaced by each other in any manner.

6. The sorting installation according to claim 2, wherein the source container revolving devices are provided as modules identical to each other so that they can be arranged in a row and can be replaced by each other in any manner.

7. The sorting installation according to claim 2, wherein the target container revolving conveying devices can be connected to each other and released from each other in the moving direction of supply and return strands of their target container and source container conveying circuits in a linearly guided manner.

8. The sorting installation according to claim 2, wherein the source container revolving devices can be connected to each other and released from each other in the moving direction of supply and return strands of their target container and source container conveying circuits in a linearly guided manner.

9. The sorting installation according to claim 2, wherein the target container revolving conveying devices and the source container revolving devices can be connected to each other and released from each other in the moving direction of supply and return strands of their target container and source container conveying circuits in a linearly guided manner.

10. The sorting installation according to claim 2, wherein at least one of the target container conveying circuit of the respective target container revolving conveyer device and the source container conveying circuit of the respective source container revolving conveyer device comprises two linear conveying paths arranged at a vertical distance from each other and provided with a respective drive means for automatically moving the target containers and the source containers, respectively, and includes a respective lift device at the respective ends of the linear conveying paths for automatically transferring the target containers and the source containers, respectively, from the one to the other linear conveying path.

11. The sorting installation according to claim 2, wherein at least one of the respective target container revolving conveying device and a respective source container revolving conveying device includes a plurality of carrying means fixedly provided in the target container conveying circuit and in a source container conveying circuit, respectively, which revolve therewith and which are for receiving target containers and source containers, respectively.

12. The sorting installation according to claim 2, wherein in at least one of the respective target container revolving conveying device and a respective source container revolving conveying device includes a plurality of target containers and source containers that are circularly conveyable.

13. The sorting installation according to claim 1, wherein the target containers and the source containers are identical to each other.

14. The sorting installation according to claim 1, wherein the revolving operation of the respective target container revolving conveying device is reversible in its direction so that the target containers in a corresponding target container conveying circuit can be conveyed selectively in the one or in the other revolving direction.

15. The sorting installation according to claim 1, wherein the target container revolving conveying devices are arranged in a row adjacent to each other with their conveying circuit planes extending parallel to each other.

16. Method for sorting articles from source containers into target containers by a sorting person in a sorting area, wherein a source container with articles assigned to said source container is automatically supplied to the sorting person, wherein by means of a plurality of target container revolving conveyer devices, which are adjacent to the sorting area and which respectively have a target container conveying circuit, wherein a corresponding conveying circuit plane of the target container conveying circuit of the respective target container revolving conveyer device extends vertically and crosses the sorting area, a plurality of target containers per target container conveying circuit are supplied to the sorting person in the sorting area along the respective target container conveying circuit in a revolving and repeated manner until the respective revolving target container is loaded with articles from the source container in a desired number.

17. The method according to claim 16, wherein then another source container with other articles assigned thereto is supplied to the sorting person for corresponding loading into the respective revolving target container, and wherein the target containers remain revolving in the target container revolving conveyer device until they are loaded with the desired articles in the respectively desired number to be then returned from the target container revolving conveyer device by means of a target container conveyer installation.

18. The method according to claim 16, wherein, when the supplied source container becomes empty before the respective target container is loaded with a desired number of the articles of the source container which has become empty, another source container with articles assigned to this source container, which correspond those of the empty source container, is supplied to the sorting person.

19. The method according to claim 16, wherein at least one source container revolving conveyer device adjacent to the sorting area supplies a plurality of source containers to the sorting person along a source container conveying circuit in a revolving and repeated manner until a predetermined number of articles are sorted from the respective source container into the target containers, and wherein by means of a source container conveying installation the source containers are supplied to and returned from the at least one source container revolving conveyer device.

20. The method according to claim 16, wherein the target containers in the respective target container conveying circuit are selectively conveyed in the one or in the other revolving direction.
